(19) United States
(12) Patent Application Publication
(10) Pub. No.: US 2024/0338806 A1
(43) Pub. Date: Oct. 10, 2024

(54) METHOD FOR SUPPORTING THE PROCESSING OF DAMAGE TO A BLADING OF A TURBOMACHINE, IN PARTICULAR A JET ENGINE, COMPUTER PROGRAM PRODUCT AND SYSTEM

(71) Applicant: Lufthansa Technik AG, Hamburg (DE)

(72) Inventors: Jan Oke PETERS, Hamburg (DE); Lukas BECHHEIM, Hamburg (DE); Lee-Roy AUTH, Egelsbach (DE)

(21) Appl. No.: 18/578,259

(22) PCT Filed: Jul. 15, 2022
(86) PCT No.: PCT/EP2022/069890

§ 371 Date: Jan. 10, 2024

(30) Foreign Application Priority Data
Jul. 15, 2021 (DE) 10 2021 118 371.5

(51) Int. Cl. G06T 7/00; B23P 6/00; F01D 21/00; G01N 21/95; G06T 7/50

(52) U.S. Cl. CPC G06T 7/0002; B23P 6/002; F01D 21/003; G01N 21/9515; G06T 7/50; F05D 2260/83

(57) ABSTRACT

The invention relates to a method (100) for supporting the processing of damage on a blading of a turbomachine (10) having a plurality of blades (11), comprising the following steps/stages: determining (103) a contour for processing (202) for mechanically processing a damaged area (20) of a first blade (11.1) of the blading and capturing (104) a first image (200) of a blade area (12) of the first blade (11.1) comprising the damaged area (20). The invention also relates to a computer program product and a system (1).

The invention relates to a method for supporting the processing of damage on a blading of a turbomachine, a computer program product and a system for supporting the processing of damage on a blading.

It is common for turbomachinery to undergo regular maintenance in order to detect damage on the blading. If the turbomachine is a jet engine, for example, mechanical damage can occur during operation, e.g. due to bird strike or particle ingress from a runway. For maintenance purposes, it is known from DE 10 2019 100 821 A1, for example, to carry out a borescope inspection of jet engines, in which three-dimensional data of the blading can also be recorded.

Furthermore, in the course of regular maintenance, the blades are usually mechanically processed if damage is detected. For example, notches in the damaged areas can be rounded out by blending the blades in order to smooth out the course of the mechanical stresses and avoid local stress peaks. This avoids the need to replace slightly damaged blades. The mechanical processing is carried out by qualified personnel through a manual grinding process. A disadvantage, however, is that the mechanical processing, in particular its reproducibility, is highly dependent on manual skills. Furthermore, the mechanical removal during blending can often be improved in terms of the amount removed.

It is an object of the present invention to at least partially eliminate the above disadvantages known from the prior art. In particular, it is an object of the present invention to enable improved processing of damage to a turbomachine, in particular with regard to material protection and/or reproducibility.

The above problem is solved by a method having the features of claim 1, a computer program product having the features of claim 14, and a system having the features of claim 15. Further features and details of the invention are apparent from the respective dependent claims, the description and the drawings. Features and details which are described in connection with the method according to the invention naturally also apply in connection with the computer program product according to the invention and/or the system according to the invention and vice versa, so that reference is or can always be made to the individual aspects of the invention with respect to the disclosure.

According to a first aspect of the invention, a method is provided for supporting processing of a damage to a blading of a turbomachine having a plurality of blades. The method comprises the following steps/stages:
Determining a contour for processing for mechanical processing of a damaged area of a first blade of the blading, in particular by a computing device of a system for supporting the processing of the damage on the blading of a turbomachine,
Capturing a first image of a blade area of the first blade with the damaged area, in particular by a recording device of the system,
Generating output image data, preferably in the form of a video signal, with a superimposition of the first image and the contour for processing, in particular by the computing device,
Outputting the output image data to enable mechanical processing of the first blade along the contour for processing, in particular by a display device of the system.

During the method, the turbomachine is preferably in a fully assembled state. The turbomachine can preferably be an engine, in particular a jet engine for an aircraft. For example, the turbomachine may be a compressor or a turbine. For the purposes of the present invention, the blading is understood to mean at least a subset, preferably the entirety, of the blades of the turbomachine. In particular, the blades may also be referred to as rotor blades or fan blades. The blades can be connected to a shaft of the turbomachine in a form-fit, force-fit and/or material-fit manner. In particular, a blade root of the blades can be integrally formed with the shaft. Preferably, the blades can be assigned and/or attached to the shaft by a form-fit.

The damaged area may, for example, be a notch on an inlet edge and/or outlet edge of the first blade. The damage to the blading can only include the damaged area or several damaged areas on the first blade or on several blades. To capture the damaged area, it may be sufficient if only the blade area with the damaged area is captured. However, it is also conceivable that the first image includes the entire blade and/or additional blades of the blading.

The recording device can preferably be a borescope. The capturing of the first image can comprise an image of the blade area, in particular a two-dimensional or three-dimensional image. The first image can be understood in particular as an image or an image section of the blade area. For example, the image can be captured by a camera, in particular by the recording device. In particular, it may be provided that the first image is digitized when the first image is captured.

In particular, the mechanical processing can include so-called blending, i.e. milling and/or grinding, in order to smooth the damaged area. It is conceivable that the contour for processing has a contiguous, in particular continuous, contour or comprises several contour sections. For example, it is conceivable that the contour sections are determined on the basis of processing data, such as radii. The contour for processing can preferably be determined using a contour specification. The contour specification can be understood to mean, for example, contour data that is specified externally for the mechanical processing of the damaged area. For example, contour data and/or the contour specification can be obtained by the computing device to determine the contour for processing and then provided to generate the output image data. It is conceivable that the contour specification is inserted manually. For example, the contour for processing on the display device, which displays the first image and/or the output image data, can be selected and/or drawn in by user interaction. Furthermore, it is conceivable that the determination of the contour for processing comprises a user dialog in order to coordinate the contour for processing with the operator.

When the first image and the contour for processing are superimposed, in particular the contour for processing can be made visible in the first image. For this purpose, the geometric data of the contour for processing can be digitally and/or visually inserted into the first image. For example, the geometric data of the contour for processing in the first image can be projected and/or transferred onto the first blade area. In particular, the output image data can comprise two-dimensional or three-dimensional image information.

Preferably, the output image data is output during the mechanical processing of the first blade. In particular, the determination of the contour for processing, the capturing of the first image, the generation of the output image data and/or the output of the output image data can take place repeatedly in order to enable the processor to perform a continuous comparison and/or to align the contour for processing with the shape contour. The output of the output image data can comprise a display of the output image data on a display device. However, it is also conceivable that the output image data is only provided in digital and/or analog form for a display device and/or sent to a display device during output. In this case, for example, the display can take place on any end device. It may also be provided that the position and/or shape of the contour for processing can be changed by user interaction after output. Preferably, the first image and the output image data are video signals or parts of video signals. In particular, the image information is thus output in the form of augmented reality, in which the contour for processing is inserted into the image signal of the recording device. In particular, the output image data can have several layers, with one layer containing the first image and another layer containing the contour for processing.

The damaged area can thus be advantageously smoothed by mechanical processing, which can reduce the notch effect. The output of the output image data in turn enables the processing process to be performed along the contour for processing, while the superimposition of the first image and the contour for processing is output in the form of the output image data. This allows a high degree of reproducibility of the processing result to be achieved, as the operator can use the contour for processing as a guide when blending the first blade. For example, the contour for processing can be used to specify the shape contour to be achieved based on the damaged shape contour of the first blade. By specifying the contour for processing to the operator, the processing result is less dependent on manual skill and/or the experience of the operator. This also reduces the amount of material that needs to be removed.

Furthermore, in a method according to the invention, advantageously it may be provided that before and/or during the capturing of the first image, recognition of an identification is performed to assign a positioning of the first blade in the turbomachine. The identification may, for example, comprise a numbering of the first blade in order to be able to localize the first blade on the circumference of a shaft of the turbomachine. Furthermore, the identification can include further information about the first blade, such as a stage of the turbomachine to which the first blade is assigned. For example, it may be provided that a blade ring, to which the first blade is assigned, is numbered circumferentially around the shaft in relation to a reference point. The reference point can be a blade lock, for example. Based on the numbering, the first blade can be positioned using a record card, for example. To recognize the identification for assigning the positioning of the first blade in the turbomachine, it is also conceivable that identification data is received. For example, the record card and/or other information can be retrieved from a data memory. By recognizing the identification, the relative position of the first blade can be found in a simple manner. For example, information about the contour for processing of the identified blade can be stored for later maintenance operations. Furthermore, if the damaged area was detected during a previous inspection, the first blade can be found for processing in a simple manner using the identification.

Preferably, in a method according to the invention, it may be provided that the method comprises the following step/stage:
Performing a data acquisition process for capturing data from at least one of the blades of a blade ring of the turbomachine, in particular by the recording device and/or the computing device.

In particular, data from all blades of the blade ring and/or the turbomachine can be captured during data capturing. Preferably, the identification is recognized during the data acquisition process. The data acquisition process can take place independently of the processing of the damaged area in terms of time and/or location. In particular, the data acquisition process takes place when the blading and/or the turbomachine is fully assembled. During the data acquisition process, an installation position of the blades can be recognized and made available for subsequent processing steps/stages. Preferably, a position of a blade lock is first determined during the data acquisition process by bringing the blade lock into the field of vision of a recording device guided through a first maintenance opening on the turbomachine by rotating the shaft. A reference blade of the blades can then be marked on a record card, which is simultaneously located in the field of vision of a recording device guided through a second maintenance opening. If the position of the maintenance openings for two recording devices is known, it is therefore possible to determine which blade is in the field of vision of one of the recording devices when the specified blade lock is in the field of vision of the other recording devices.

Furthermore, advantageously in a method according to the invention, it may be provided that geometry data, in particular in the form of three-dimensional geometry data, of the first blade are recognized during the capturing of the first image and/or during the data acquisition process, preferably for recognizing the identification of the first blade. For this purpose, the recording device can have several cameras and/or a stereo camera. Preferably, the recording device is a borescope for recording three-dimensional images. The geometry data can advantageously be taken into account when determining the contour for processing and/or during superimposition. This allows the contour for processing to be adapted or added to an edge of the first blade, for example. Furthermore, the geometry data can include, for example, damaged area data for classifying and/or localizing the damaged area. It is also conceivable that image features of the first blade are extracted from the geometry data to identify the first blade during the data acquisition process and when capturing the first image. In particular, the image features of the first blade can be provided by the data acquisition process in order to enable identification during the capturing of the first image on the basis of the geometry data, in particular on the basis of the comparison of the geometry data.

It is also conceivable in a method according to the invention that an outer shape contour of the blade area is recognized when the first image is captured, in particular wherein the determination of the contour for processing and/or the superimposition of the first image with the contour for processing is performed depending on the shape contour. The outer shape contour can, for example, comprise a line of a shape and/or edge of the first blade. In particular, a skeleton model of the first blade or blades can be created from the geometry data to recognize the shape contour. The outer shape contour can advantageously be recognized from the geometry data. During superimposition, the contour for processing can be applied to the mold contour so that the contour for processing is tangential to the mold contour, at least in sections. This reliably prevents new notches from being created unintentionally during processing. Furthermore, the contour for processing can be determined depending on the shape contour. For example, a line of the mold contour, such as the course of an inlet or outlet edge of the first blade, can be used as a starting point for determining the contour for processing. This allows the contour for processing to be advantageously matched to the mold contour.

Preferably, in a method according to the invention, it can be provided that, depending on the geometry data, the contour for processing is aligned with the damaged area in the output image data when the first image and the contour for processing are superimposed. It can be provided that the contour for processing is automatically aligned with the position of the damaged area during the superimposition. In particular, the localization of the damaged area can be taken into account when determining the contour for processing. As a result, it is not necessary for an operator to align the contour for processing with the damaged area, e.g. by changing the position of the recording device. Preferably, the shape contour of the first blade can also be taken into account. It is conceivable that when the first image is captured, the damaged area is localized depending on the geometry data, in particular depending on a comparison of the geometry data of the first image and the data acquisition process. For example, the geometry data can be used to determine a distance of the damaged area from a reference of the first blade, such as a blade head or a blade root. The localization of the damaged area can be taken into account when determining the contour for processing. For example, a minimum processing radius and/or a maximum processing depth for material removal can depend on the localization of the damaged area, in particular in relation to the expected stress state during operation of the turbomachine. It is also conceivable that the localized damaged area is visually highlighted when the output image data is generated in order to make it easier for an operator to find the damaged area.

Furthermore, in a method according to the invention, it may advantageously be provided that a damage analysis process for automatically evaluating the damaged area is performed and preferably taken into account when determining the contour for processing, in particular wherein a geometry parameter is compared with at least one geometry threshold value. The damage analysis process can include a classification of the damaged area. For example, the classification can indicate whether repair of the damaged area is necessary, permissible or impermissible. In order to classify the damaged area, it is possible to check whether the geometry parameter is below or above a geometry threshold value. It is also conceivable that, when classifying the damaged area, a check is made as to whether the geometry parameter lies within a permissible repair region. The permissible repair region can advantageously be defined by an upper and/or a lower geometry threshold value. The geometry parameter can include, for example, a depth of the damaged area based on the shape contour of the first blade. The automatic evaluation can support an operator in deciding whether a repair should be carried out. It can also be used to determine and/or optimize the material removal required to achieve the contour for processing.

Furthermore, in a method according to the invention, it is conceivable that the determination of the contour for processing comprises a calculation of the contour for processing taking into account the damaged area and the geometry data. The contour for processing can, for example, be output to an operator as a suggestion, which the operator can accept, reject and/or modify. When automatically calculating the contour for processing, the contour for processing can be optimized with regard to the strength properties of the processed blade and/or with regard to the volume of material removed during mechanical processing. It is conceivable that at least one radius, in particular an aperture radius, and/or at least one length, in particular an aperture length, of the contour for processing are determined as a function of a depth, in particular an aperture depth, of the contour for processing. The depth of the contour for processing can be determined by the depth of the damaged area. Furthermore, the automatic calculation can further improve the reproducibility of the processing result. Preferably, the contour for processing can comprise output data from an artificial intelligence. For example, the artificial intelligence can be trained using simulation results from strength calculations and/or thermodynamic calculations in order to provide the contour for processing and/or machine-specific processing data of the contour for processing as output data.

Furthermore, in a method according to the invention, it can advantageously be provided that machine-specific processing data of the turbomachine is read out from a database to determine the contour for processing. The database can be integrated into a server. However, it is also conceivable that the database is provided in a mobile end device. The database can be a manufacturer-specific database. For example, the database can include processing data from turbomachines from a specific manufacturer. The processing data can include geometric processing data, such as maximum permissible milling radii. It is also conceivable that the processing data could include legal specifications. By reading from the database, the machine-specific processing data can be taken into account when determining the contour for processing. As a result, the contour for processing can be improved on a machine-specific basis, particularly with regard to material removal.

Furthermore, in a method according to the invention, it may advantageously be provided that the method comprises the following step/stage:
Determining an imbalance parameter of the turbomachine depending on the contour for processing and/or the processing of the first blade, in particular by the computing device.

The imbalance parameter can comprise an imbalance and/or a change in the imbalance depending on the processing of the first blade. Furthermore, several damaged blades can be taken into account when determining the imbalance parameter. The imbalance parameter can be used to recognize whether an imbalance is to be expected for the shaft to which the first blade is assigned as a result of the processing. As a result, corresponding technical problems in the operation of the turbomachine can be avoided. The determination of the imbalance parameter can be carried out in particular before, during and/or after the determination of the contour for processing or after processing. It is also conceivable that the determination of the imbalance parameter and the determination of the contour for processing can be performed iteratively. As a result, both parameters can be optimized to reduce imbalance and to process the damaged area in a way that is gentle on the material.

Furthermore, in a method according to the invention, it may advantageously be provided that the method comprises the following step/stage:
Determining a second blade of the blading for additional processing depending on the imbalance parameter, in particular by the computing device.

Preferably, the second blade is determined depending on the data acquisition process. The second blade is preferably a blade of the turbomachine opposite the first blade, in particular radially and/or axially opposite. The additional processing of the second blade and the processing of the first blade can have the same processing parameters or different ones. For example, the processing can be repeated for the second blade as part of the additional processing. As a result, any imbalance caused by the processing can be at least partially or completely corrected. The data acquisition process makes it easy to locate the second blade, in particular without the need for manual counting. As a result, errors can be avoided, making the processing of the damage more reproducible overall.

Within the scope of the invention, it is further conceivable that the method comprises the following steps/stages:
Determining an additional contour for processing for mechanical processing of the second blade depending on the contour for processing and/or the imbalance parameter, in particular by the computing device,
Capturing a second image of at least one region of the second blade, in particular by the recording device,
Generating further output image data with a superimposition of the second image with the additional contour for processing, in particular by the computing device,
Outputting the further output image data to enable the additional processing of the second blade along the additional contour for processing, in particular by the display device.

This means that the steps/stages for supporting the mechanical processing of the first blade can be repeated for the second blade. The additional contour for processing can correspond to the contour for processing or have a different shape. For example, the additional processing can be adapted to an outer shape contour of the second blade if the outer shape contour of the first blade deviates from the shape contour of the second blade. Preferably, the additional contour for processing can be determined depending on the imbalance parameter. This allows the additional processing to be performed with minimal material removal to compensate for the imbalance. By generating and outputting the further output image data, the processing of the second blade can be carried out just as reproducibly as the processing of the first blade. In particular, an operator can thus be supported during the entire processing of the blading damage.

Furthermore, in a method according to the invention, it can advantageously be provided that the geometry data, in particular in the form of three-dimensional geometry data, is updated after processing only for the processed blades, in particular only for the first and second blades. This means that the existing geometry data can be kept up to date and made available for validation by the authorities or the manufacturer, for example. By assigning the geometry data to the individual blades, the additional work involved in updating the data can be kept to a minimum if only the modified, i.e. processed, blades are captured and/or measured again.

According to a further aspect of the invention, a computer program product is provided. The computer program product comprises instructions which, when executed by a computing device, cause the computing device to execute a method according to the invention.

Thus, a computer program product according to the invention has the same advantages as those already described in detail with reference to a method according to the invention. In particular, the method may be a computer-implemented method. The computer program product may be implemented as computer-readable instruction code in any suitable programming language such as JAVA, C++, C# and/or Python. The computer program product may be stored on a computer-readable storage medium such as a data disk, a removable drive, a volatile or non-volatile memory, or a built-in memory/processor. The instruction code can influence and/or control a computer or other programmable devices such as the computing device in such a way that the desired functions are executed. Furthermore, the computer program product can be made available or provided on a network, such as the Internet, from which it can be downloaded by a user on demand. The computer program product can be realized through software as well as through one or more special electronic circuits, i.e. in hardware or in any hybrid form, i.e. through software components and hardware components.

According to a further aspect of the invention, a system for supporting the processing of damage to a blading of a turbomachine having a plurality of blades is provided. The system comprises a display device for displaying output image data and a computing device for executing a method according to the invention.

Thus, a system according to the invention has the same advantages as those already described in detail with reference to a method according to the invention and/or a computer program product according to the invention. Preferably, the system further comprises a recording device, for example in the form of a borescope, for capturing the first image of the first blade. However, it is also conceivable that the first image is captured using data technology via an interface of the computing device. The output image data is preferably output by the computing device to the display device in order to display the output image data to an operator via the display device. The computing device and the display device can be integrated into a mobile end device, such as a tablet or part of maintenance equipment. However, it is also conceivable that the system has a server in which the computing device is at least partially or fully integrated, in particular where the output image data is transmitted from the server to the display device. It is also conceivable that the computing device has several modules that are distributed decentrally. In this way, an operator of the system can be supported in a convenient manner when processing the damage to the blading in order to achieve an improved processing result, in particular with regard to material removal and/or reproducibility.

Further advantages, features and details of the invention are shown in the following description, in which embodiments of the invention are described in detail with reference to the drawings. The features mentioned in the claims and in the description may be essential to the invention individually or in any combination. It shows schematically:

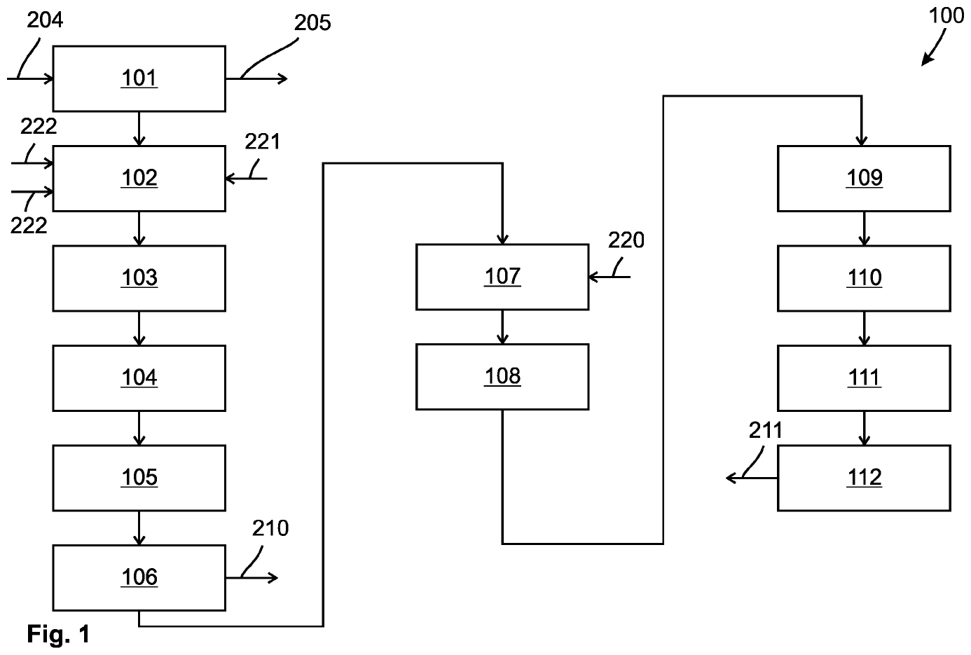

FIG. 1 A method according to the invention for supporting the processing of damage to a blading of a turbomachine comprising a plurality of blades,

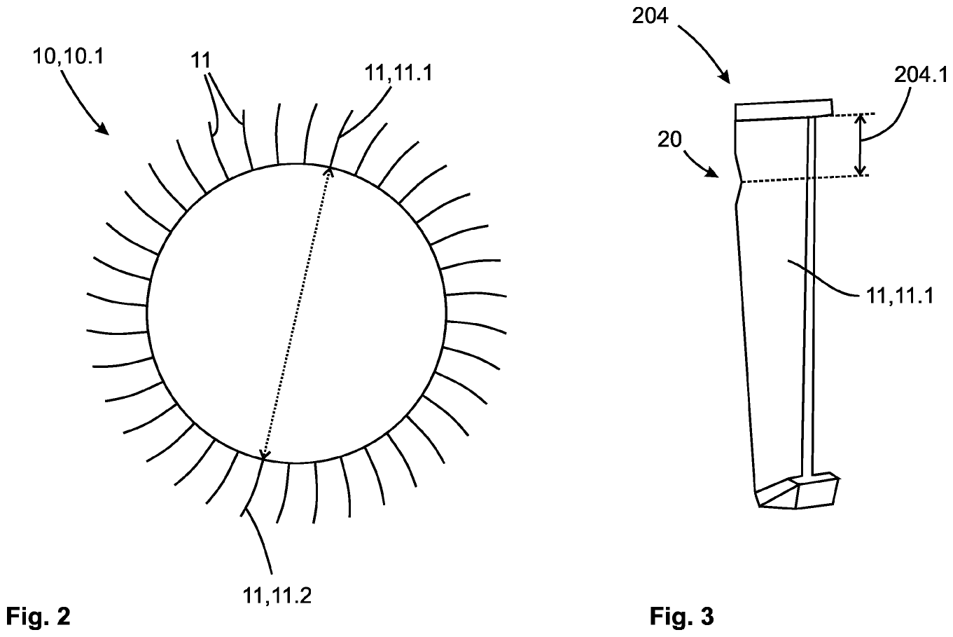

FIG. 2 The blading of the turbomachine,

FIG. 3 A first blade of the blading,

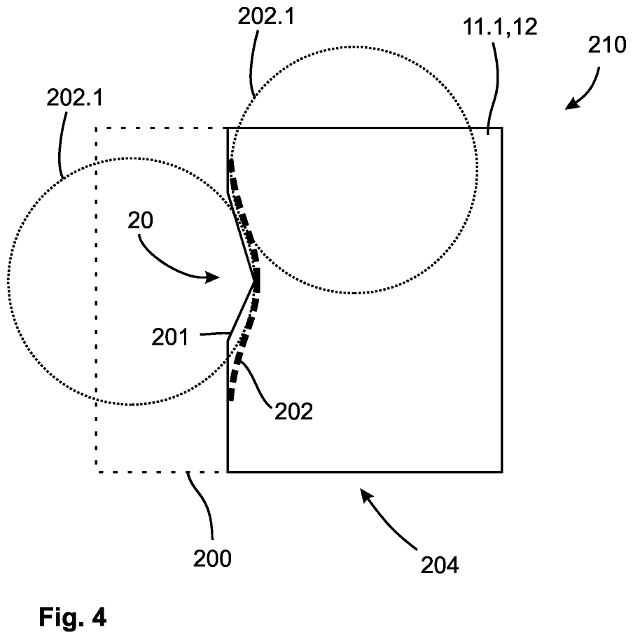

FIG. 4 A superimposition of a first image assigned with the first blade and a contour for processing before mechanical processing,

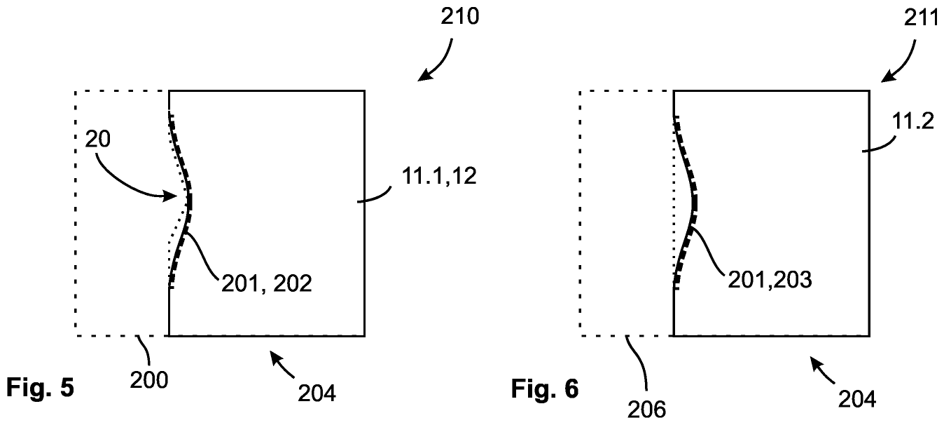

FIG. 5 The superimposition of the first image and the contour for processing after mechanical processing,

FIG. 6 A superimposition of a second image and an additional contour for processing after mechanical processing of a second blade,

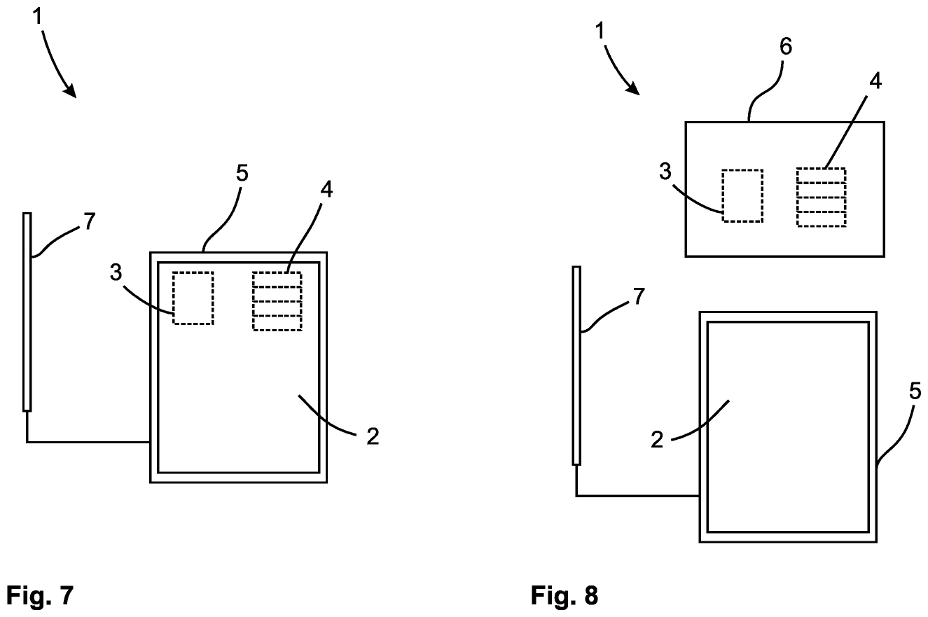

FIGS. 7 and 8 A system according to the invention in various embodiments.

In the following description of some embodiments of the invention, the identical reference signs are used for the same technical features even in different embodiments.

FIG. 1 shows a method 100 for supporting the processing of damage to a blading of a turbomachine 10 comprising a plurality of blades 11 in a schematic representation of method steps/stages. A blade ring 10.1 of the blading of the turbomachine 10 is shown as an example in FIG. 2. For example, the turbomachine 10 can be a jet engine of an airplane.

According to FIG. 1, the method 100 initially involves performing a data acquisition process 101, preferably to identify all blades 11 of the blade ring 10.1 of the turbomachine 10. This allows the individual blades 11 to be identified in a simple manner for carrying out the subsequent method steps/stages. For example, an identification 205 can be recognized for each of the blades 11 during the data acquisition process 101. For this purpose, a specific blade 11 can be assigned to a position according to a record card in order to be able to assign all blades 11 in their position to a reference point, such as a blade lock, starting from the already identified blade 11. Furthermore, geometry data 204, in particular in the form of three-dimensional geometry data 204, of the blades 11 can already be recognized during the data acquisition process 101. For example, a digital model can be created using the data acquisition process 101. Advantageously, as shown in FIG. 3, localization data 204.1 of a damaged area 20 of a first blade 11.1 of the blades 11 can be recognized.

A damage analysis process 102 can then advantageously be performed to automatically evaluate the damaged area 20. The geometry data 204 of the blades 11, in particular with regard to the damaged area 20, are evaluated. As shown in FIG. 3, for example, the localization data 204.1, in particular in the form of a height of the damaged area 20 starting from a blade root or a blade head of the first blade 11.1, can be captured. Preferably, at least one geometry parameter 221 of the damaged area is captured using the geometry data 204 and compared with at least one geometry threshold value 222, preferably two geometry threshold values 222. This makes it possible to recognize whether the size of the damaged area 20 is still within a permissible repair region between the geometry threshold values 222. For example, if the damaged area 20 is a crack or tear in the first blade 11.1, the length of the damaged area 20, in particular starting from an edge of the first blade 11.1, can be determined and/or evaluated during the damage analysis process 102. In particular, the damage analysis process 102 can be used to classify the damaged area 20.

Furthermore, the method 100 comprises capturing 104 a first image 200 of a blade area 12 of the first blade 11.1 of the blading comprising the damaged area 20. The first image 200 with the blade area 12 is shown in FIG. 4. The first image 200 can be provided in the form of an image signal, in particular in the form of a video signal. Preferably, the identification 205 for assigning a positioning of the first blade 11.1 in the turbomachine 10 is also recognized during the capturing 104 of the first image 200. As a result, the first blade 11.1 can be automatically assigned to the geometry data 204 and/or vice versa captured during the data acquisition process 101. Additionally or alternatively, geometry data 204 of the first blade 11.1 can also be recognized during the capturing 104 of the first image 200. Thus, it is conceivable that the geometry data 204 captured in this way is compared with the geometry data 204 of the data acquisition process 101 and/or the data acquisition process 101 takes place simultaneously with the capturing 104 of the first image 200. Preferably, during the capturing 104 of the first image 200, the damaged area 20 is localized depending on the geometry data 204, in particular depending on a comparison of the geometry data 204 of the first image 200 and the data acquisition process 101.

In particular, using the geometry data 204, an outer shape contour 201 of the blade area 12 can advantageously be recognized when capturing 104 the first image 200. The shape contour 201 can, for example, comprise at least in sections an inlet edge and/or an outlet edge of the first blade 11.1.

Furthermore, the method 100 comprises determining 103 a contour for processing 202 for mechanically processing the damaged area 20. Determining 103 the contour for processing 202 can take place before and/or after capturing 104 the first image 200. However, it is also conceivable that the determination 103 of the contour for processing 202 takes place simultaneously with the capturing 104 of the first image 200. The contour for processing 202 is shown as an example in dashed form in FIG. 4 and corresponds to a target contour for processing which an operator should achieve during mechanical processing of the first blade 11.1 in order to smooth the damaged area 20 and thereby reduce a notch effect. For this purpose, it may be provided that the operator mechanically processes the first blade 11.1 by so-called blending, i.e. by grinding and/or milling. FIG. 5 shows the processing result, in which the outer mold contour 201 with the damaged area 20 is configured in such a way that the previously existing notch is eliminated and a tangential course according to the contour for processing 202 forms the corrected outer mold contour 201.

The operator is supported in that output image data 210 is generated 105 with an overlay of the first image 200 and the contour for processing 202 and the output image data 210 is output 106. During the superimposition, in particular an image plane with the first image 200 is superimposed with an image plane with the contour for processing 202. The output image data 210 with the superimposition can then be displayed to the operator via a display device 2 of the system 1, so that the operator can orient himself to the contour for processing 202 during mechanical processing of the first blade 11.1. In particular, at least the capturing 104 of the first image 200 and the generation 105 of the output image data 210 take place during the mechanical processing, so that the operator can permanently compare his processing result with the contour for processing 202. In particular, the determination 103 of the contour for processing 202 can be carried out repeatedly in order to align the contour for processing 202 with the shape contour 201.

Advantageously, the contour for processing 202 is calculated when determining 103 the contour for processing 202 by a computing device 3 of a system 1 according to the invention for supporting the processing of the damage. For example, the damage analysis process 102, the geometry parameter 221 of the damaged area 20 and/or the geometry data 204 of the first blade 11.1, such as the shape contour 201, can be taken into account. Additionally or alternatively, machine-specific processing data 202.1, such as predetermined radii or a predetermined depth, of the turbomachine 10 can be read out from a database 4 of the system 1 in order to determine the contour for processing 202.

The determination 103 of the contour for processing 202 and/or the superimposition of the first image 200 with the contour for processing 202 takes place depending on the shape contour 201. Thus, depending on the geometry data 204, the contour for processing 202 can be aligned with the damaged area 20 in the first image 200 when the first image 200 and the contour for processing 202 are superimposed. Thus, in particular, the localization of the damaged area 20 can be taken into account when determining 103 the contour for processing 202.

Depending on the size of the damaged area 20, the mechanical processing of the first blade 11.1 can lead to an imbalance of a shaft of the turbomachine 10. Preferably, therefore, an imbalance parameter 220 of the turbomachine 10 is determined 107 as a function of the contour for processing 202 and/or the processing of the first blade 11.1. The imbalance parameter 220 can be used to check whether the imbalance that arises or has arisen is in an impermissible region.

In order to compensate for the imbalance, the method 100 advantageously further comprises determining 108 a second blade 11.2 of the blading for additional processing depending on the imbalance parameter 220. For example, the result of the data acquisition process 101 can be used to determine the second blade 11.2. The support for the processing of the first blade 11.1 can then be applied analogously to the second blade 11.2. As shown in FIG. 6, this involves determining 109 an additional contour for processing 203 for mechanical processing of the second blade 11.2 depending on the contour for processing 202 and/or the imbalance parameter 220, capturing 110 a second image 206 of the second blade 11.2, a generation 111 of further output image data 211 with a superimposition of the second image 206 with the additional contour for processing 203, and an output 112 of the further output image data 211 in order to enable the additional processing of the second blade 11.2 along the additional contour for processing 203. Subsequently, an imbalance parameter 220 can be determined again iteratively 107 with subsequent additional processing.

After processing, it may be provided that the geometry data 204, in particular in the form of three-dimensional geometry data 204, are updated only for the processed blades 11.1, 11.2, in particular only for the first and second blades 11.1, 11.2. In particular, the geometry data 204 of the corresponding blade 11 can be updated after each processing of one of the blades 11.

FIGS. 7 and 8 each show a system 1 for processing the damage to the turbomachine 10 in different embodiments. In each case, the system 1 has a display device 2 for displaying output image data 210 and a computing device 3 for executing a method 100 according to the previously described embodiment example. For this purpose, the computing device 3 may, for example, execute a computer program product comprising instructions that cause the computing device 3 to perform the method 100. Furthermore, a database 4 for providing machine-specific processing data 202.1 may be provided. The display device 2 is preferably integrated into a mobile end device 5, such as a tablet or smartphone. The computing device 3 and the database 4 can also be integrated into the mobile end device, as shown in FIG. 7. It is also conceivable that the computing device 3 and the database 4 are integrated into a server 6, as shown in FIG. 8. The server 6 and the end device 5 can communicate via wireless communication links, for example. Preferably, the system 1 further comprises a recording device 7, in particular in the form of a borescope, for capturing geometry data 204 and/or the first image 200 of the first blade 11.1.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System
2 Display device
3 Computing device
4 Database
5 End device
6 Server
7 Recording device
10 Turbomachine
11 Blades
10.1 Blade ring
11.1 First blade
11.2 Second blade
12 Blade area
20 Damaged area
100 Method
101 Data acquisition process
102 Damage analysis process
103 Determining 202
104 Capturing 200
105 Generating 210
106 Outputting from 210
107 Determining 220
108 Determining 11.2
109 Determining 203
110 Capturing 206
111 Generating 211
112 Outputting from 211
200 Image
201 Shape contour
202 Contour for processing
202.1 Processing data
203 Additional contour for processing
204 Geometry data
204.1 Localization data
205 Identification
206 Second image
210 Output image data
211 Further output image data
10)
220 Imbalance parameters
221 Geometry parameters
222 Geometry threshold value

1. A method for supporting the processing of damage to a blading of a turbomachine having a plurality of blades,
comprising the following stages:
Determining a contour for processing for mechanically processing a damaged area of a first blade of the blading,
Capturing a first image of a blade area of the first blade having the damaged area,
Generating output image data with a superimposition of the first image and the contour for processing,
Outputting the output image data to enable mechanical processing of the first blade along the contour for processing, and
Determining an imbalance parameter of the turbomachine depending on at least the contour for processing or the processing of the first blade.

2. The method according to claim 1,
wherein
an identification for assigning a positioning of the first blade in the turbomachine is recognized at least before or during the capturing of the first image.

3. The method according to claim 1,
wherein
the method comprises the following stage:
Performing a data acquisition process for capturing data from at least one of the blades of a blade ring of the turbomachine.

4. The method according to claim 1,
wherein
geometry data, of the first blade is recognized at least during the capturing of the first image or during the data acquisition process.

5. The method according to claim 1,
wherein
an outer shape contour of the blade area is recognized during the capturing of the first image, wherein at least the determination of the contour for processing or the superimposition of the first image with the contour for processing takes place depending on the shape contour.

6. The method according to claim 1,
wherein,
depending on the geometry data, when the first image and the contour for processing are superimposed, the contour for processing is aligned with the damaged area in the output image data.

7. The method according to claim 1,
wherein
a damage analysis process for automatically evaluating the damaged area is performed and taken into account when determining the contour for processing.

8. The method according to claim 1,
wherein
the determination of the contour for processing comprises a calculation of the contour for processing taking into account the damaged area and the geometry data.

9. The method according to claim 1,
wherein
machine-specific processing data of the turbomachine are read out from a database in order to determine the contour for processing.

10. (canceled)

11. The method according to claim 1,
wherein
the method comprises the following stage:
Determining a second blade of the blading for additional processing depending on the imbalance parameter.

12. The method according to claim 1,
wherein
the method comprises the following stages:
Determining an additional contour for processing for mechanical processing of the second blade depending on at least the contour for processing or the imbalance parameter,
Capturing a second image of at least one region of the second blade,
Generating further output image data with a superimposition of the second image with the additional contour for processing,
Outputting the further output image data to enable the additional processing of the second blade along the additional contour for processing.

13. The method according to claim 1,
wherein
the geometry data is updated after processing only for the processed blades (11.1, 11.2).

14. A computer program product comprising instructions which, when executed by a computing device, cause the computing device to execute a method according to claim 1.

15. A system for supporting the processing of damage to a blading of a turbomachine having a plurality of blades, comprising
a display device for displaying output image data, and
a computing device for executing a method according to claim 1.

16. The method according to claim 3,
wherein
the identification is recognized during the data acquisition process.

17. The method according to claim 4,
wherein
the geometry data is in the form of three-dimensional geometry data.

18. The method according to claim 7,
wherein
a geometry parameter is compared with at least one geometry threshold value.

19. The method according to claim 10,
wherein
the second blade is determined depending on the data acquisition process.

20. The method according to claim 12,
wherein
the geometry data is updated after processing only for the first and second blades.
